(19) United States
(12) Patent Application Publication
(10) Pub. No.: US 2026/0046980 A1
(43) Pub. Date: Feb. 12, 2026

(54) A POWER CONTROL DEVICE

(71) Applicant: Graphite Energy (Assets) PTY Limited, Surry Hills (AU)

(72) Inventors: Dimiter Nedialkov, Bondi (AU); Bandon Yu, Leichardt (AU); Bryon Ross, Surry Hills (AU); Jason Ho, West Hoxton (AU)

(21) Appl. No.: 19/099,642

(22) PCT Filed: Jul. 27, 2023
(86) PCT No.: PCT/AU2023/050684

§ 371 Date: Jan. 29, 2025

(30) Foreign Application Priority Data
Jul. 29, 2022 (AU) 2022902137

(51) Int. Cl. H05B 1/02; H02J 1/10; H02J 3/14

(52) U.S. Cl. CPC H05B 1/0225; H02J 1/106; H02J 3/14

(57) ABSTRACT

A power control device 100 for an electrical load. The power control device 100 has an input 120 for receiving electrical power; an output 140 for supplying electrical power from the input to the electrical load; and a control module 160 for controlling the supply of electrical power to the electrical load from the output. The control module 160 is configured to define a plurality of discrete power-on timings, over a time period, during which electrical power is supplied from the output for powering the electrical load.

### CROSS-REFERENCE TO RELATED APPLICATIONS

This application is the U.S. national phase application of International Application No. PCT/AU2023/050684, filed on Jul. 27, 2023, which claims the benefit of priority to Australia Provisional Application No. 2022902137, filed on Jul. 29, 2022, the entire contents of which are incorporated by reference.

### FIELD

The present invention relates to a power control device for controlling when power is supplied to an electrical load.

### BACKGROUND

In a traditional system including a plurality of electrical devices, such as electric heaters or other electrical devices that have a relatively slow response to electrical power, the electrical load will vary depending on various factors such as changes in temperature or changes in system demand. The variations can create large power fluctuations at the upstream side of the power distribution network, which can make the supply and protection of electricity difficult. For example, the rapidly changing loads (potentially swinging from nothing to full power demand in a very short period of time) can cause problems with cables, connectors, electrical harmonics, protective devices, measurement devices, signalling devices among other issues.

These issues are exacerbated in a traditional system that has a large number of high-power devices where an instantaneous demand from the devices can cause instability in the power supply system.

### SUMMARY OF INVENTION

It is an object of preferred embodiments of the invention to address the disadvantages described above and/or to at least provide the public with a useful choice.

An aspect of the present invention provides a power control device for an electrical load, the power control device including: an input for receiving electrical power; an output for supplying electrical power from the input to the electrical load; a control module for controlling the supply of electrical power to the electrical load from the output, the control module being configured to define a plurality of discrete power-on timings, over a time period, during which power is supplied from the output for powering the electrical load; and a randomiser module configured to randomise the plurality of power-on timings over time.

The plurality of power-on timings defined by the control module is random over time.

In an alternative embodiment, the power control device may be part of a system comprising a plurality of electrical loads each to which a respective power control device is connected, and the plurality of power-on timings of the power control device may be synchronised with power-on timings of one or more other power control devices in the system. In this alternative embodiment, the power control devices in the system may be configured to limit a total number of power-on timings across the power control devices in the system at any given time. For example, at any given time, only one electrical load in the system may be powered. Alternatively, at any given time, up to 80% of the plurality of electrical loads, or up to 70% of the plurality of electrical loads, or up to 60% of the plurality of electrical loads, or up to 50% of the plurality of electrical loads may be powered.

The input of the power control device may receive electrical power an alternating current (AC) power source or receive electrical power from a direct current (DC) power source.

Preferably, the power control module is selectively configurable to define a time period including one or more timings of the plurality of power-on timings. Where the power control device is connected to an AC power source, the control module may be configured to split, over the time period, the electrical power received by the input into a discrete number of half or full AC cycles, the one or more timings of the plurality of power-on timings preferably corresponding to a subset of the discrete number of half or full AC cycles.

Preferably, the control module is configured to segment the time period into a plurality of segments, the one or more timings of the plurality of power-on timings corresponding to a subset of the plurality of segments. For example, the control module may segment the time period into about 128 discrete segments. Each discrete segment may be about 10 ms.

The time period may be selectively configurable to at least one of less than 1 second, 1 second, less than 5 seconds, 5 seconds, less than 10 seconds, 10 seconds, or more than 10 seconds. Preferably, the time period up to about 4 seconds, up to about 3 seconds, or up to about 2 seconds. Further preferably, the time period is about 1.5 seconds.

The plurality of power-on timings is selectively adjustable with respect to the time period. The power-on timings may be selectively adjustable to up to 100% of the time period. For example, the plurality of power-on timings is selectable to be any one of 10%, 20%, 30%, 40%, or 50% with respect to the time period.

Another aspect of the present invention provides an electrical load including the power control device according to the aspect previously described.

A further aspect of the present invention provides an electrical load including: an electrical component that is powered by electrical power, the electrical component for providing an output response; a control module for controlling the electrical component, the control module being configured to define a plurality of discrete power-on timings, over a time period, during which the electrical component is powered to provide the output response; and a randomiser module configured to randomise the plurality of power-on timings over time.

The plurality of power-on timings as defined by the control module is random over time.

The features of control module of the electrical load according to this aspect of the invention are similar to the features of the control module of the power control device of the aspect previously described above.

The electrical load is preferably an electrical load that has a slow response. For example, the electrical load is a resistive heater.

Yet a further aspect of the present invention provides a system comprising a plurality of electrical loads, each electrical load having the power control device of the aspect previously described above or being the electrical load of any of the aspects previously described above.

### BRIEF DESCRIPTION OF DRAWINGS

Preferred embodiments of the invention will now be described, by way of non-limiting example, with reference to the accompanying drawings in which:

FIG. 1 shows a system diagram of a power control device according to an embodiment of the present invention; and

FIGS. 2A, 2B, and 2C show load responses for a traditional system and a system with the power control device(s) according to an embodiment of the present invention comprising 1, 10, and 64 electrical loads respectively.

### DESCRIPTION OF EMBODIMENTS

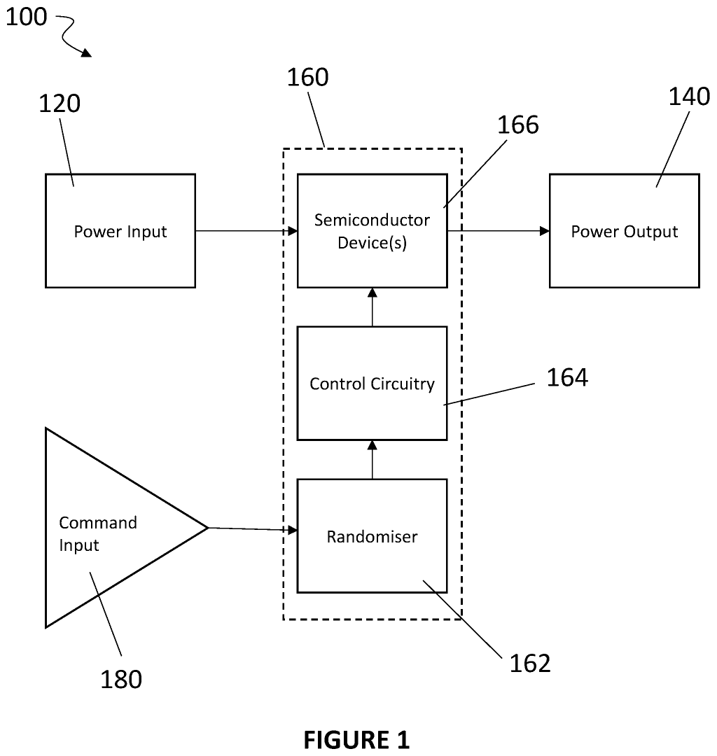

With reference to FIG. 1, a power control device 100 for an electrical load according to a preferred embodiment of the present invention includes an input 120 for receiving electrical power from a power supply; an output 140 for supplying electrical power from the input to the electrical load; and a control module 160 for controlling the supply of electrical power to the electrical load from the output. The power control device further includes an input module 180 for receiving one or more inputs to adjust an operation of the control module 160. The inputs include an input that defines timings during which the electrical load is powered, which may be up to 100% of the time period.

The power control device 100 is used in a system that includes a plurality of electrical loads, each to which a respective power control device according to a preferred embodiment of the invention is connected. The power control device 100 is suited to an electrical load that has a slow response to the supplied electrical power relative to the frequency of the electrical power control. By way of example, the electrical load is a resistive heater. This type of electrical load takes time to reach a desired operating state. For example, in the case of an electric heater, the electric heater takes time to heat up to a desired temperature level.

The input 120 is configured to receive electrical power from a power source. By way of example, the power source may be a mains power grid or an independent power supply. The input of the power control device may receive electrical power an alternating current (AC) power source or receive electrical power from a direct current (DC) power source.

The output 140 is connected to the electrical load to which power from the input 120 is to be supplied. By way of example, the output has an electrical port to which the electrical load is connectable.

The control module 160 is configured to define a plurality of discrete power-on timings, over a time period, during which power is supplied from the output 140 of the power control device 100 for powering the electrical load. In a scenario where the electrical power is AC electrical power, each discrete power-on timing corresponds to one full or half AC cycle in the electrical signal received by the input 140. The time period, in a preferred embodiment, may consist of 128 discrete timings, each discrete timing being configurable as a power-on timing and being about 10 ms. Electrical power is only supplied to the electrical load during a power-on timing. For example, in the case of a resistive heater, supplying electrical power thereto would increase the operating temperature of the heating element or would, if the heating element is already at the desired operating temperature, maintain the operating temperature of the heating element. Outside a power-on timing, a supply of electrical power to the electrical load is discontinued. Because the electrical load has a slow response, the electrical load would continue to provide some output for a period of time after electrical power is discontinued to the electrical load.

In a scenario where the electrical power is DC electrical power, the control module is configured to segment the time period into a plurality of segments, the one or more timings of the plurality of power-on timings corresponding to a subset of the plurality of segments. For example, the control module may segment the time period into about 128 discrete segments, each discrete segment being about 10 ms.

The control module 160 of the power control device is configured to randomise the power-on timings over time. In this regard, the control module 160 has a randomiser module 162, control circuitry 164 for receiving a signal from the randomiser module 162 and convert the signal to a control signal for driving a semiconductor device 166 that is configurable to allow or discontinue a supply of power from the input 120 to the output 140. The randomiser module 162 develops the on-off timings of the semiconductor devices 164 over the time period. The semiconductor devices 164 consist of one or more switches that control the power delivery from the input module 120 to the output module 140. For example, the semiconductor devices 164 may consist of triacs, insulated-gate bipolar transistors (IGBTs), metal-oxide semiconductor field-effect transistors (MOSFETs), bipolar junction transistors (BJTs), silicon-controlled rectifiers (SCRs), or any other switch. In this embodiment, the power-on timings configured by the control module of the power control device 100 in the system are independent of the power-on timings configured by the control module of other power control devices in the system.

According to the embodiment described with reference to FIG. 1, the randomiser module 162 is included in the power control device. In other examples, the randomiser module may be externally located to the power control device. In these other examples, the randomiser module may be connected to the control circuitry of the control module of the power control device via a wired or wireless connection. For example, the power control device may have a communications module for facilitating communication with the externally-located randomiser module. The externally-located randomiser module may be in communication with one power control device or may be in communication with a plurality of power control devices in the system. For example, the externally-located randomiser module may have, or implement, a plurality of channels each of which is allocatable to a respective power control device and the randomiser module is configured to generate a randomised control signal for each channel. The randomised control signals on the plurality of channel are independent of each other. The number of channels of the randomiser module may be configurable by the user depending on the number of electrical loads in the system to be controlled.

The input module 180 provides an input to the control module 160 to selectively configure the power control module 160 to define a time period during which one or more power-on timings are to occur and a duty cycle, being the amount of time the semiconductors will be ON in the configured time period. The control module 160 is further configured to split, over the time period, the electrical power received by the input into a discrete number of half or full AC cycles, the one or more timings of the plurality of power-on timings corresponding to a subset of the discrete number of half or full cycles. By way of example the input module 180 can be configured to set the time period to about 1.5 seconds. This short time period is preferred because it provides responsiveness while allowing a large enough time for the probabilistic approach that is implemented by the control module 160 to be useful. In other examples, the input module 180 can be configured to set the time period to less than 1 second, 1 second, less than 5 seconds, 5 seconds, less than 10 seconds, 10 seconds, or more than 10 seconds. Preferably, the time period up to about 4 seconds, up to about 3 seconds, or up to about 2 seconds.

The input module 180 further provides an input to the control module 160 to set a ratio or percentage of power on timings with respect to the time period. The power-on timings may be selectively adjustable to up to 100% of the time period. For example, the plurality of power-on timings is selectable to be any one of 10%, 20%, 30%, 40%, or 50% with respect to the time period.

Because the power-on timings of the power control devices in the system are independent of each other and random, there is a low probability of all electrical loads or a large number of electrical loads being powered at the same time that would cause instability to the upstream power supply. This probability of instability to the upstream power supply decreases when the number of electrical loads having the power control devices in the system increases. By randomly choosing the period when the device takes its power, large current spikes in a multi-device system can be minimised and the effective stabilisation of current draw will improve at scale. This is due to the ability of a random noise to tend towards zero/an offset.

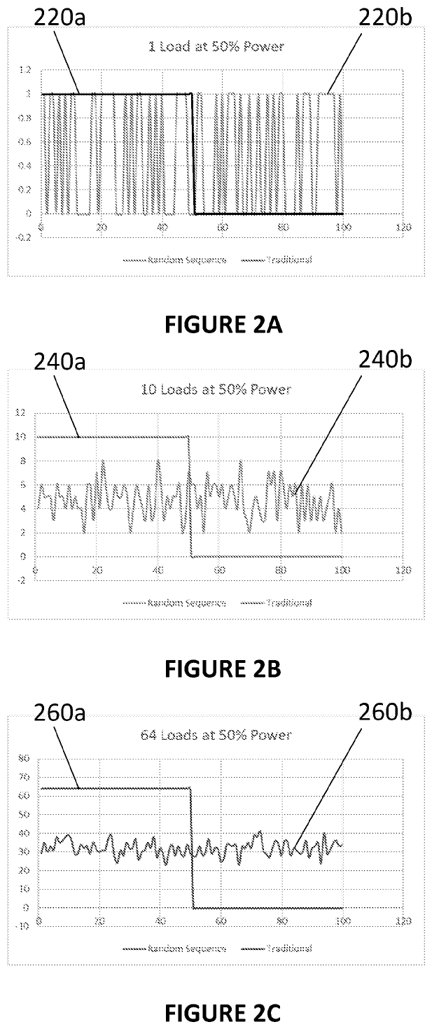

FIGS. 2A to 2B show the load responses over time for 1, 10, and 64 loads each operating at 50% power. The period in the x-axis in these figures is about 1 second, or 100 half cycles on a 50 Hz low voltage distribution network.

FIG. 2A shows the load response 220a in a traditional system having one electrical load, and the load response 220b in a system having one electrical load with the power control device 100 according to the preferred embodiment of the present invention in which the control module randomizes the power-on timings during which power is provided to the electrical load. In both cases, the electrical load is powered 50% of the time. There is little difference to the upstream power supply since in either case 220a and 220b, the power supply provides power to one electrical load at any given time.

FIG. 2B shows the load response 240a in a traditional system having ten electrical loads, and the load response 240b in a system having ten electrical loads each having the power control device 100 in which the control module provides random and independent power-on timings during which power is provided to the respective electrical loads. In both cases, the electrical loads are powered 50% of the time. From the response 240a of the traditional system, power is supplied to all ten electrical loads during the first 50 half cycles and then discontinued for the second 50 half cycles. In contrast, from the response 240a of the system with the power control devices according to the present invention, the electrical loads are randomly and independently powered at different times during the period shown. In this example response 240b, there is a maximum of eight devices that are powered at a given time—80% of devices powered at any given time).

FIG. 2C shows the load response 260a in a traditional system having 64 electrical loads, and the load response 240b in a system having 64 electrical loads each having the power control device 100 in which the control module provides random and independent power-on timings during which power is provided to the respective electrical loads. In both cases, the electrical loads are powered 50% of the time. From the response 260a of the traditional system, power is supplied to all 64 electrical loads during the first 50 half cycles and then discontinued for the second 50 half cycles. The high-power demand in the first 50 cycles and then no power demand for the next 50 cycles in the traditional system is a rapid change that causes instability to the upstream power supply. In contrast, from the response 260a of the system with the power control devices according to the present invention, the electrical loads are randomly and independently powered at different times during the period shown. In this example response 240b, there is a maximum of about 40 devices that are powered at a given time—62.5% of electrical devices powered at any given time.

In an alternative embodiment, the control module of the power control module is synchronised with other power control devices in the system such that the number of electrical loads in the system that are powered at any given time is limited to a number that does not cause instability to the upstream power supply. For example, at any given time, only one electrical load in the system may be powered. Alternatively, at any given time, up to two electrical loads, up to three electrical loads, or up to five electrical loads may be powered. Further alternatively, at any given time, up to 80% of the plurality of electrical loads, or up to 70% of the plurality of electrical loads, or up to 60% of the plurality of electrical loads, or up to 50% of the plurality of electrical loads may be powered.

The power control device 100 is removably connectable with respect to the electrical load. In alternative embodiments, features of the power control device are integral with the electrical load. For example, the electrical load includes: an electrical component that is powered by electrical power, the electrical component for providing an output; and a control module for controlling the electrical component, the control module being configured to define a plurality of power-on timings during which the electrical component is powered. The plurality of power-on timings as defined by the control module is preferably random over time. Alternatively, the control module of the electrical load may be synchronised with the control modules of other electrical loads in the system.

The various embodiments of the present invention described above have been presented by way of example only, and not by way of limitation. It will be apparent to a person skilled in the relevant art that various changes in form and detail can be made therein without departing from the spirit and scope of the invention. The present invention should not be limited by any of the exemplary embodiments described above.

1. A power control device for an electrical load, the power control device including:
an input for receiving electrical power;
an output for supplying electrical power from the input to the electrical load;
a control module for controlling the supply of electrical power to the electrical load from the output, the control module being configured to define a plurality of discrete power-on timings, over a time period, during which electrical power is supplied from the output for powering the electrical load; and
a randomiser module configured to randomise the plurality of power-on timings over time.

2. The power control device of claim 1, wherein the randomiser module is configured to randomise the plurality of power-on timings over time such that, in a system that includes a plurality of electrical loads each to which a respective one of a plurality of power control devices, which includes the power control device, is connected, there is a low probability of all electrical loads being powered at the same time that would cause instability to an upstream power supply.

3. The power control device of claim 2, wherein the power-on timings of the power control device are independent of power-on timings of other power control device(s) of the plurality of power control devices in the system.

4. The power control device of claim 2, wherein the randomiser module is in communication with the plurality of power control devices in the system, wherein the randomiser module has or implements a plurality of channels each of which is allocatable to a respective one of the plurality of power control devices and the randomiser module is configured to generate a randomised control signal for each channel.

5. The power control device of claim 4, wherein a number of channels of the randomiser module is configurable by the user depending on the number of electrical loads in the system to be controlled.

6. The power control device according to claim 1, wherein the power control module is selectively configurable to define the time period.

7. The power control device according to claim 6, wherein the control module is configured to split, over the time period, the electrical power received by the input into a discrete number of half or full AC cycles, the one or more timings of the plurality of power-on timings corresponding to a subset of the discrete number of half or full cycles.

8. The power control device according to claim 6, wherein the control module is configured to segment the time period into a plurality of segments, the one or more timings of the plurality of power-on timings corresponding to a subset of the plurality of segments.

9. The power control device according to claim 6, wherein the time period is selectively configurable to up to about 4 seconds, up to about 3 seconds, up to about 2 seconds, or about 1.5 seconds.

10. The power control device according to claim 6, wherein the plurality of power-on timings is selectively adjustable with respect to the time period.

11. The power control device according to claim 10, wherein the plurality of power-on timings is selectable to be up to 100% of the time period, such as any one of 10%, 20%, 30%, 40%, or 50% with respect to the time period.

12. An electrical load including the power control device according to claim 1.

13. An electrical load including:
an electrical component that is powered by electrical power, the electrical component for providing an output response;
a control module for controlling the electrical component, the control module being configured to define a plurality of discrete power-on timings, over a time period, during which the electrical component is powered to provide the output response; and
a randomiser module configured to randomise the plurality of power-on timings over time.

14. The electrical load of claim 13, wherein the randomiser module is configured to randomise the plurality of power-on timings over time such that, in a system that includes a plurality of electrical loads, which includes the electrical load, there is a low probability of all electrical loads being powered at the same time that would cause instability to an upstream power supply.

15. The electrical load of claim 14, wherein the power-on timings for the electrical load are independent of power-on timings for other electrical loads in the system.

16. The electrical load of claim 14, wherein the randomiser module has or implements a plurality of channels each of which is allocatable to a respective one of the plurality of electrical loads and the randomiser module is configured to generate a randomised control signal for each channel.

17. The electrical load of claim 16, wherein a number of channels of the randomiser module is configurable by the user depending on the number of electrical loads in the system to be controlled.

18. The electrical load of claim 12, wherein the electrical load is a resistive heater.
